(19) United States
(12) Patent Application Publication
(10) Pub. No.: US 2016/0125353 A1
(43) Pub. Date: May 5, 2016

(54) CONCURRENTLY USING MULTIPLE UNITS OF MEASURE FOR INVENTORY MANAGEMENT

(71) Applicant: ORACLE INTERNATIONAL CORPORATION, Redwood Shores, CA (US)

(72) Inventors: Rebecca MAIFELD, Brooklyn Park, MN (US); Steven GOOIJER, Maple Grove, MN (US); Charles J. HAHR, JR., Roberts, WI (US)

(21) Appl. No.: 14/526,830

(22) Filed: Oct. 29, 2014

(51) Int. Cl. G06Q 10/08

(52) U.S. Cl. CPC G06Q 10/087

(57) ABSTRACT

Systems, methods, and other embodiments associated with concurrently using multiple units of measure are described. In one embodiment, a method includes providing, on an electronic display, a user interface that includes a representation of at least one product by generating the user interface with a selected one of two or more units of measure for the product according to at least a context of the user interface. The context is defined according to at least a role of the user interface within an inventory management system. The two or more units of measure include a standard unit of measure and at least one transaction unit of measure. The method includes maintaining, in an electronic database that includes records of an inventory, one or more records associated with the product by maintaining the records concurrently using the two or more units of measure.

### BACKGROUND

Computer systems and manual processes have been used to manage product inventories for organizations. Managing product inventories that include many different types of products can present unique difficulties. For example, the types of products may include groceries (e.g., produce, grains, etc.), electronics, clothing and so on. In general, the products may be sold according to discrete units (e.g., one package) or measured units (e.g., grams). However, while a product may be sold according to one unit of measure, that same product may be managed within an inventory management system according to a completely different unit. Thus, tracking quantities of products in an inventory is complicated when units of measure used to account for those products differ at various stages.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a device associated with concurrently using multiple units of measure for products in an inventory.

FIG. 2 illustrates another embodiment of a method associated with managing an inventory of products using multiple units of measure for each product in the inventory.

FIG. 3 illustrates an embodiment of a computing system configured with the example systems and/or methods disclosed.

### DETAILED DESCRIPTION

Computerized systems and methods are described herein that provide for concurrently using multiple units of measure to electronically track and manage products in an inventory management system. In one embodiment, a product is defined in an electronic database according to a standard unit of measure and at least two transaction units of measure.

The standard unit of measure is, for example, a unit of measure that is standard within an industry for tracking a product within an inventory management system. Accordingly, the standard unit of measure generally relates to the product in a bulk form (e.g., bushels, bolts, etc.). By contrast, the transaction unit of measure is, for example, a unit of measure that is relevant to single transactions and single order fulfillment in relation to a consumer transaction context. In general, the transaction unit of measure is a unit associated with fine grain measurement for transactions such as consumer/retail transactions and fulfillment of the transactions.

Thus, in one embodiment, the inventory management system maintains records related to a single product by concurrently using multiple units of measure instead of using only a single unit of measure that does not properly translate to different contexts (e.g., wholesale vs retail sales).

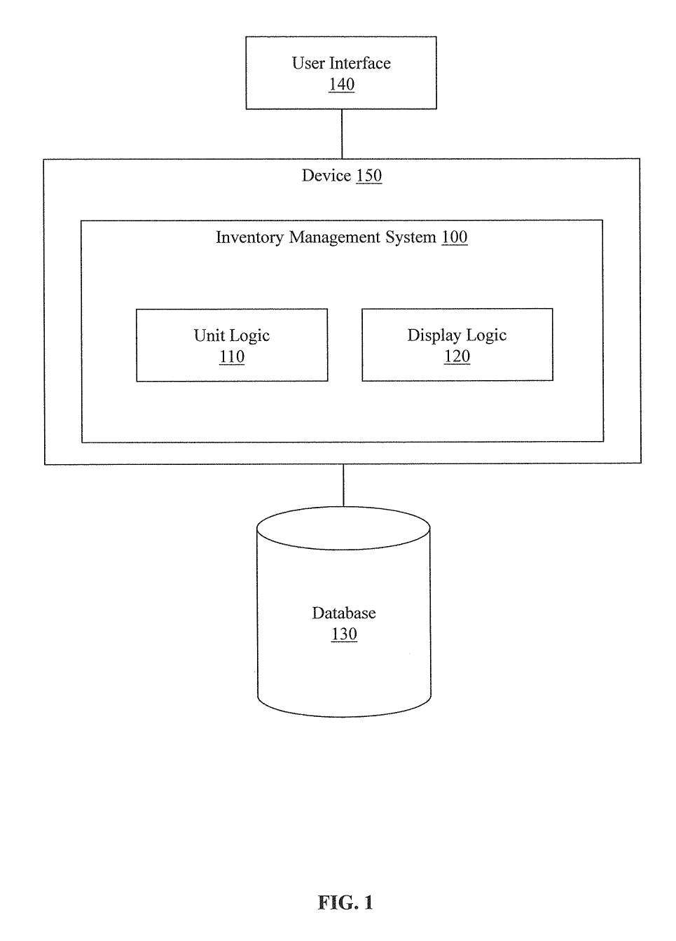

With reference to FIG. 1, one embodiment of an inventory management system 100 associated with concurrently maintaining multiple units of measure for a product is illustrated. In general, the system 100 may be an inventory management system that includes many different aspects for managing and tracking a supply chain of products. The supply chain of products may include wholesale procurement, warehousing, retail distribution, retail sales, order fulfillment and picking, inventory/sales analysis and so on. Thus, each of the different aspects of the system 100 uses data about products in an inventory in different ways.

In one embodiment, the inventory management system 100 is an application or collection of distributed applications for enterprise organizations that are executable by device 150 using at least a processor and memory. The applications and system 100 may be configured to operate with or be implemented as a cloud-based networking system, a software as a service (SaaS) architecture, or other type of networked computing solution or data processing system. In one embodiment the inventory management system 100 is a centralized server-side application that is accessed by many users via computing devices/terminals communicating with the system 100 (functioning as the server) over a network. In general, the inventory management system 100 operates within an electronic environment of the device 150 by communicating over one or more electronic communication networks, generating and manipulating electronic data in the form of electronic data objects and so on.

In one embodiment, the system 100 includes unit logic 110 and display logic 120. The unit logic 110 is configured to, for example, manage product records in a database 130 as part of the inventory management system. The records are electronic data structures defined and manipulated as part of the database 130 but other types of electronic data structures can be used. The unit logic 110 is configured to update quantities of available inventory, ordered inventory and so on by converting between multiple units of measure for a product or updating separate quantities stored in the multiple units of measure.

The display logic 120 is configured to provide various user interfaces 140 for the inventory management system by causing the interfaces to be rendered on an electronic display associated with, for example, the device 150 or a remote device to which electronic communications are provided over an electronic communications network. The various user interfaces include information about the products in various contexts of the inventory management system such as sales, management, fulfillment and so on.

Consequently, depending on a context associated with a respective user interface, the display logic 120 is configured to generate the user interface using a unit of measure selected from multiple units defined for the product. The selected unit of measure is a unit that is relevant to the context of the user interface in order to provide a unit that is applicable to how the product is being viewed. For example, transaction units of measure are units of measure for measuring the product in a consumer transaction context as opposed to a standard unit of measure which is applicable in a management context (e.g., wholesale or inventory tracking). In this way, products are displayed in such a way that viewing or performing actions relevant to the product is easily understood within the provided context.

In one embodiment, the unit logic 110 is configured to initially define a product by defining a standard unit of measure and at least one transaction unit of measure along with other attributes of the product (e.g., name, price, etc.). In general, the unit logic 110 defines the product by generating an electronic data object that represents the product in the database 130.

Furthermore, in one embodiment, the unit logic 110 defines each product to include one standard unit of measure. The standard unit of measure is generally a unit of measure associated with bulk quantities of the product by which the product may be tracked and managed within the inventory management system. Furthermore, the standard unit of measure may be a unit that is standardized for a particular industry and by which industry practice typically dictates the product is measured. Examples of a standard unit of measure include bolts for fabric, bushels for produce/grain, barrels for beer, rounds for cheese or deli meats, cases, crates and so on.

By contrast, the transaction unit of measure is generally any other unit by which the product may be measured. The transaction unit of measure may be a standardized unit or a non-standardized unit. Non-standardized units may include local/traditional measuring methods (e.g., by the bag, spoonful or hand). Standardized units are regulated according to a standards body and may include units such as gram, pound, liter, yard and so on. In either case, the transaction unit of measure is a unit by which the product is generally valued for sale within a consumer transaction context (e.g., retail sales). That is, the transaction unit of measure is used to value a quantity of the product at a granularity of an individual consumer transaction and/or fulfillment of that transaction. Thus, generally, the transaction unit of measure is a smaller unit of measure (e.g., gram vs kilogram).

For example, procurement and warehousing aspects of an inventory management system handle bulk quantities of the product. Thus, when generating a user interface to be viewed from a procurement context (i.e., also referred to more generally as a management context), the display logic 120 provides a standard unit of measure (e.g., cases or bushels) that is common for wholesaling the product as the relevant unit. By contrast, when a consumer is purchasing the product through an electronic commerce source (i.e., consumer transaction context), the display logic 120 provides a user interface with the product using a transaction unit of measure (e.g., pounds).

Thus, each different aspect of the inventory management system may have correlating user interfaces that view the inventory from a unique context with associated relevant units of measure. Accordingly, the display logic 120 is configured to generate a user interface for a product according to a context within which the user interface is to be viewed. As used within this disclosure, context is intended to refer to attributes that uniquely define a particular viewing of a user interface or communication (e.g., notification/request). As one example, the attributes may include geographic region, societal standards, user preference, government regulations, common transacting quantities and so on.

Additionally, the transaction unit of measure can be defined according to whichever unit is desired for a particular implementation. Thus, the unit logic 110 is configured to define each product with as many transaction units of measure as may be applicable to an implementation. For example, the unit logic 110 may define a fabric to have a standard unit of measure of bolts while providing for transaction units of measure in yards, feet and/or meters. In this way, the system 100 may concurrently maintain multiple units of measure for a product while providing interfaces and/or notifications with a relevant one of the multiple units of measure when transitioning through different aspects of the inventory management system. Of course, while the standard unit of measure and the transaction unit of measure are discussed in relation to generally applicable circumstances, actual units for both types of units can be customized for a particular implementation.

Now consider an example where a user interface associated with sales is provided and a subsequent order for a product is generated. In this example, the product is generally any consumer goods such as fabric, grocery items and so on. Accordingly, after the product has initially been defined in the database 130, the display logic 120 may provide a user interface 140 that includes a display of the product. In general, the display logic 120 is configured to generate the user interface 140 according to a context as previously discussed.

Suppose that the display logic 120 generates the user interface 140 for an electronic commerce website. The display logic 120 generates the user interface 140 according to the context by accounting for attributes that define the context. The attributes are associated with viewing the user interface 140 and may include a geographic location from where the user interface 140 will be viewed and an intended use/role (e.g., sales, fulfillment) of the user interface 140. The display logic 120 may also account for other factors when generating the user interface 140 such as user preferences, local customs/norms, societal standards, government regulations, transacting quantities and so on.

Thus, the display logic 120 produces the user interface 140 with a depiction of the product and a selected unit of measure as either the standard unit of measure or one of the transaction units of measure defined for the product. For this example, assume that the user interface 140 is a user interface for selling the product and is to be viewed from San Francisco, Calif. Accordingly, the display logic 120 generates the user interface 140 using a unit of measure that accounts for conventions associated with units in San Francisco, Calif.. Thus, in this example, the unit may be selected to correlate common units within the United States and for a role of selling the product in a consumer transaction context.

Consequently, the transaction unit of measure may be yards for fabric or pounds for meat. The display logic 120 selects yards and pounds according to the context instead of, for example, bolts for the fabric or kilograms for the meats because the user interface 140 is intended for retail transactions in U.S. customary units as opposed to wholesale transactions or metric units.

Furthermore, while a single transaction unit of measure is discussed as being selected according to the context, in one embodiment, additional transaction units of measure may also be selectable. That is, even though the display logic 120 determines which transaction unit of measure is appropriate for the current context, additional transaction units of measure that are defined for the product can be made selectable in order to provide for whichever option of units may be preferred by a user.

Continuing with the example, suppose that a user interacts with the user interface 140 and causes an order to be generated. In general, the order indicates a product and an ordered quantity of the product specified in a selected transaction unit of measure. Accordingly, the system 100 receives an electronic communication that includes the order over an electronic communication network (e.g., the Internet).

In one embodiment, the unit logic 110 is configured to generate one or more requests/notifications in response to receiving the order. Of course, while a consumer order is discussed, it should be appreciated that other events within the system 100 may cause the unit logic 110 to generate a request/notification. For example, the unit logic 110 may generate requests upon notification of updates to inventory, for generating various statistical reports and so on.

In either case, the unit logic 110 is configured to update the database 130 with information from the order so as to track and maintain records of the inventory in the database 130. In one embodiment, the records for the product are updated and maintained in a single unit of measure, which is the standard unit of measure for the product. Thus, for each transaction that occurs in relation to the product, whichever unit of measure the transaction occurs in is automatically converted into the standard unit of measure before the database 130 is updated to reflect the order. In general, the same is true for any modification to quantities stored in the database 130 that relate to the product.

The unit logic 110 converts quantities in transaction units of measure from various requests/notifications into the standard unit of measure prior to updating records in the database 130. In this way, the system 100 can concurrently maintain records relating to the product in multiple units of measure and provide contextual displays relating to the product with a unit of measure that is most relevant to the display.

Of course, while converting to a single unit of measure is discussed, in one embodiment, the unit logic 110 is configured to concurrently maintain records about the product in multiple units of measure. That is, the unit logic 110 may update and maintain records for the product in multiple separate units of measure that are defined for the product. When updating in this manner, the unit logic 110 is configured to, for example, convert a quantity into all of the stored units in order to update all of the units of measure individual for stored quantities.

Continuing with the previous example of the order, in one embodiment, in response to the order, the unit logic 110 generates requests for updating the database 130, requesting fulfillment of the order and any other notifications/requests that are used to track the order and maintain inventory records in the database 130. In one embodiment, the unit logic 110 generates each of the notifications/requests according to a context of the respective notifications/requests in a similar manner as discussed with generating the user interface 140 according to the context.

Additionally, in one embodiment, the display logic 120 provides different user interfaces for different aspects of the inventory management system. The different user interfaces may include a fulfillment interface that is provided to fulfill the order. Thus, the display logic 120 is configured to generate the user interfaces in a similar manner as the user interface 140 discussed previously. That is, the display logic 120 generates each separate user interface according to a context of the user interface to provide a unit of measure that is relevant to a current viewing of the product within the inventory management system.

Thus, according to a context of a given notification/request or different user interface, the unit logic 110 automatically converts quantities associated with the product from the standard unit of measure, as stored in the database 130 to whichever unit of measure is selected for the respective notification/request or different user interface. Subsequently, the display logic 120 generates the user interface 140 with the quantity provided by the unit logic 110 if a different user interface is to be provided.

Of course, in an embodiment where quantities are stored in multiple units of measure, the unit logic 110 converts a stored quantity when a selected unit of measure is not already stored in the database. That is, if a value in the selected units is not available in the database, then the unit logic 110 will convert a stored value from whichever unit to the selected unit. In this way, the system 100 may concurrently provide information regarding a product in multiple units of measure.

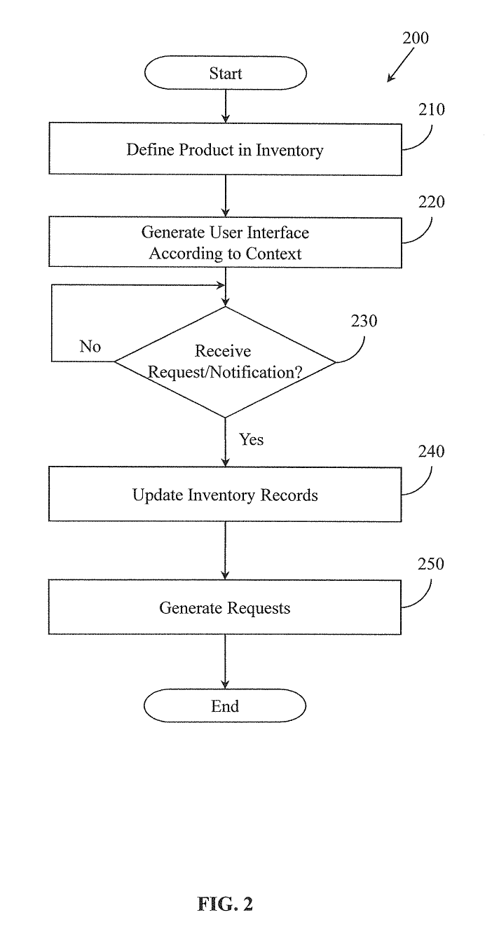

Additional aspects of concurrently using multiple units of measure in an inventory management system will be discussed in relation to FIG. 2. FIG. 2 illustrates a method 200 associated with managing an inventory while concurrently using multiple units of measure.

At 210, a product is defined in an electronic database. In one embodiment, the product is defined according to a plurality of attributes that include two or more units of measure associated with the product. The two or more units of measure include a standard unit of measure and multiple transaction units of measure as discussed previously.

In general, the product is any consumer good that may be tracked using an inventory management system. In one embodiment, the electronic database is a database that includes records for the inventory management system relating to a plurality of products, sales of the products, and so on. The inventory management system is a system for tracking and maintaining inventory records related to products sold through a commercial retail location and/or an electronic commerce source (i.e., website). Thus, the inventory management system provides for tracking and maintaining records of the inventory through many different aspects of supply chain management and order fulfillment.

For example, the inventory management system may include functionality related to wholesale procurement, warehouse management, e-commerce ordering and fulfillment, sales analysis and so on. Accordingly, the inventory management system and records associated with the inventory management system that are stored and defined in the electronic database may be viewed and interacted with from many different perspectives. The different perspectives, or, otherwise referred to as contexts, include viewing the inventory with different purposes and thus according to different units (e.g., bulk vs transactional). Furthermore, the products may be viewed from different geographic regions within which different units are common.

Therefore, at 220, a user interface is generated according to a context within which the user interface will be displayed. In one embodiment, generating the user interface includes generating the user interface with whichever one of the multiple units of measure is applicable to the context of the user interface. In one embodiment, the context depends on a set of factors. The set of factors may include a role of the user interface and various other attributes of how and where the user interface is being viewed.

For example, the role is defined according to which aspect of the inventory management system is associated with the user interface. Thus, as one example, if the user interface is generated for a fulfillment or sales role then a unit of measure that is provided would be a transaction unit of measure. Which particular transaction unit of measure would further depend on the set of factors such as geographic location (e.g., Europe vs United States) and so on. By contrast, if the role is warehousing or some other supply chain role then the unit of measure may be the standard unit of measure since units would be most relevantly viewed as the industry standard.

At 230, a request or notification is received that is associated with one or more products in the inventory. In one embodiment, the request is an order for a product. In another embodiment, the request/notification is an electronic update to quantities in inventory and so on.

At 240, inventory records are updated in response to the request/notification from 230. In one embodiment, updating the inventory includes converting quantities from a unit of measure in the request/notification (e.g., a transaction unit of measure) to the standard unit of measure as the product is stored in the electronic database. In this way, products in the inventory can be concurrently used with multiple different units of measure.

At 250, one or more additional requests may be generated in response to the request/notification from 230. In one embodiment, the additional requests include requests to fulfill an order, updates to available quantities in inventory and so on. In general, additional requests such as the request to fulfill the order are also generated according to a context, a context of the request, however. In this way, units included with the requests are within context and provide for using the request or notification in a relevant manner.

Additionally, in one embodiment, a computing device is implemented with an executable algorithm that is configured to perform the method 200.

Computer Embodiment

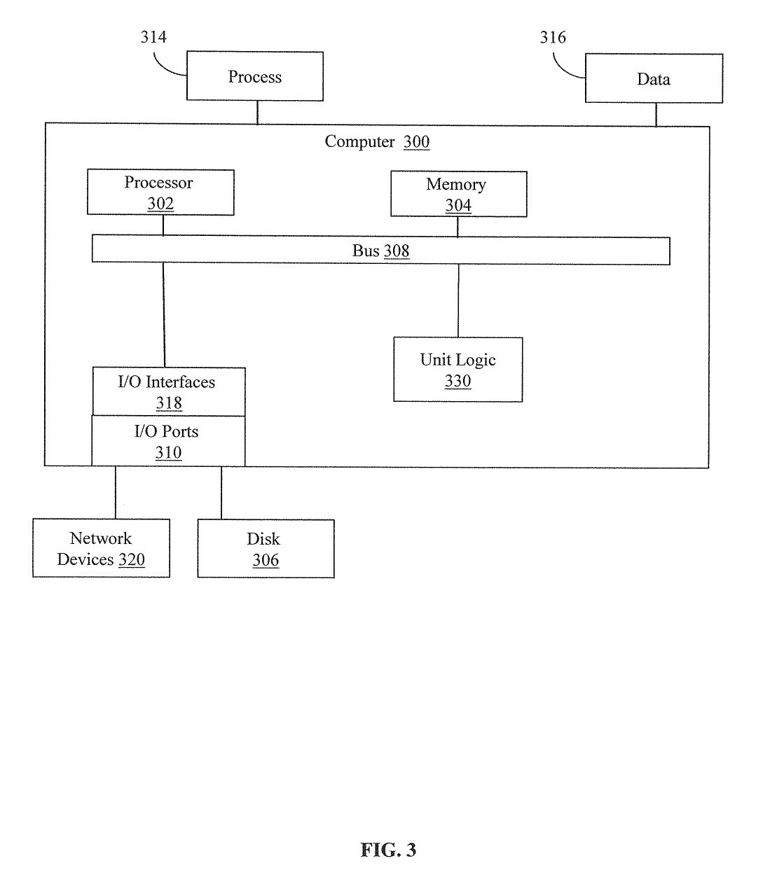

FIG. 3 illustrates an example computing device that is configured and/or programmed with one or more of the example systems and methods described herein, and/or equivalents. The example computing device may be a computer 300 that includes at least a processor 302, a memory 304, and input/output ports 310 operably connected by a bus 308. In one example, the computer 300 may include unit logic 330 configured to facilitate tracking and maintaining products in an inventory by concurrently using multiple units of measure similar to system 100 shown in FIG. 1. In different examples, the logic 330 may be implemented in hardware, a non-transitory computer-readable medium with stored instructions of an executable application, firmware, and/or combinations thereof. While the logic 330 is illustrated as a hardware component attached to the bus 308, it is to be appreciated that in one example, the logic 330 could be implemented in the processor 302, or stored in memory 304 or disk 306.

In one embodiment, logic 330 or the computer is a means (e.g., hardware, non-transitory computer-readable medium, firmware) for defining products and receiving/processing orders for the products in an inventory management system. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to define the products, process orders, and generate various requests associated with the orders and other notifications in the inventory management system. The means may also be implemented as stored computer executable instructions that are presented to computer 300 as data 316 that are temporarily stored in memory 304 and then executed by processor 302.

Logic 330 may also provide means (e.g., hardware, non-transitory computer-readable medium that stores executable instructions, firmware) for generating a user interface in the inventory management system according to a context.

Generally describing an example configuration of the computer 300, the processor 302 may be a variety of various processors including dual microprocessor and other multi-processor architectures. A memory 304 may include volatile memory and/or non-volatile memory. Non-volatile memory may include, for example, ROM, PROM, and so on. Volatile memory may include, for example, RAM, SRAM, DRAM, and so on.

A storage disk 306 may be operably connected to the computer 300 via, for example, an input/output interface (e.g., card, device) 318 and an input/output port 310. The disk 306 may be, for example, a magnetic disk drive, a solid state disk drive, a floppy disk drive, a tape drive, a Zip drive, a flash memory card, a memory stick, and so on. Furthermore, the disk 306 may be a CD-ROM drive, a CD-R drive, a CD-RW drive, a DVD ROM, and so on. The memory 304 can store a process 314 and/or a data 316, for example. The disk 306 and/or the memory 304 can store an operating system that controls and allocates resources of the computer 300.

The computer 300 may interact with input/output devices via the i/o interfaces 318 and the input/output ports 310. Input/output devices may be, for example, a keyboard, a microphone, a pointing and selection device, cameras, video cards, displays, the disk 306, the network devices 320, and so on. The input/output ports 310 may include, for example, serial ports, parallel ports, and USB ports.

The computer 300 can operate in a network environment and thus may be connected to the network devices 320 via the i/o interfaces 318, and/or the i/o ports 310. Through the network devices 320, the computer 300 may interact with a network. Through the network, the computer 300 may be logically connected to remote computers. Networks with which the computer 300 may interact include, but are not limited to, a LAN, a WAN, and other networks.

Definitions and Other Embodiments

In another embodiment, the described methods and/or their equivalents may be implemented with computer executable instructions. Thus, in one embodiment, a non-transitory computer storage medium is configured with stored computer executable instructions of an algorithm/executable application that when executed by a machine (e.g., processor, computer, and so on) cause the machine (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, and other media from which a computer, a processor or other electronic device can function with. Each type of media, if selected for implementation in one embodiment, includes stored instructions of an algorithm configured to perform one or more of the disclosed and/or claimed functions. Computer-readable media described herein are limited to statutory subject matter under 35 U.S.C §101.

“Logic”, as used herein, includes a component that is implemented with computer or electrical hardware, firmware, a non-transitory medium with stored instructions of an executable application or program module, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, all of which are configured to perform one or more of the disclosed functions. Logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

An “operable connection”, or a connection by which entities are “operably connected”, is one in which signals, physical communications, and/or logical communications may be sent and/or received. An operable connection may include a physical interface, an electrical interface, and/or a data interface to communicate over a network (e.g., local area network, Internet, etc.). An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium storing instructions for execution by a device, the non-transitory computer-readable medium comprising:
instructions for defining, in an electronic database that includes a record of an inventory, a product by concurrently defining at least (i) a standard unit of measure for the product and (ii) two or more transaction units of measure for the product,
wherein the two or more transaction units of measure are units used to value the product in different contexts, wherein the standard unit of measure is a unit of measure used to electronically track the product within an inventory management system that includes the record of the inventory; and
instructions for providing a user interface associated with the product that includes one of the two or more transaction units of measure or the standard unit of measure according to at least the context of the user interface,
wherein the context is defined according to at least a role of the user interface within the inventory management system.

2. The non-transitory computer-readable medium of claim 1, wherein the standard unit of measure is defined as a unit of measure that is standardized for accounting for quantities of the product in a management context that includes tracking the product in the electronic database,
wherein the two or more transaction units of measure are defined as units of measure for measuring the product in a transaction context, wherein the management context defines a set of attributes associated with managing the inventory, wherein the transaction context defines a set of attributes associated with one or more of retail transactions of the product, and wherein the consumer transaction context varies according to a geographic region, societal standards, user preference, government regulations, and transacting quantities.

3. The non-transitory computer-readable medium of claim 1, wherein records for the products are concurrently maintained in the two or more transaction units of measure and the standard unit of measure, wherein the role is defined according to a use of the user interface in the inventory management system, and wherein the use includes sales, management and product fulfillment and wherein the instructions for defining the product include instructions for generating an electronic data object that represents the product.

4. The non-transitory computer-readable medium of claim 1, further comprising:
instructions for generating an electronic update to the record of the inventory in response to receiving an order for the product that specifies an ordered quantity in a selected one of the two or more transaction units of measure, wherein generating the update includes converting the ordered quantity to the standard unit of measure from the selected one of the two or more transaction units of measure and wherein the electronic update is communicated over an electronic communication network.

5. The non-transitory computer-readable medium of claim 4, wherein generating the electronic update includes generating one or more electronic requests associated with the order that specify the ordered quantity in a unit of measure according to a context of each of the one or more requests, wherein the one or more requests are requests to different aspects of the inventory management system to track and maintain records related to the product by concurrently using the standard unit of measure and the two or more transaction units of measure.

6. The non-transitory computer-readable medium of claim 1, wherein the instructions for providing the user interface includes instructions for automatically converting a relevant quantity of the product from the standard unit of measure to one of the two or more transaction units of measure, and wherein the selected one of the two or more transaction units of measure is selected according to a context of the user interface.

7. The non-transitory computer-readable medium of claim 1, wherein instructions for providing the user interface includes instructions for causing a graphical user interface that includes a representation of the product to be rendered, wherein defining the product includes generating an object in the electronic database that represents the product, and wherein generating the object includes generating a plurality of attributes of the product that include the standard unit of measure and the at least two transaction units of measure.

8. The non-transitory computer-readable medium of claim 1, wherein the two or more transaction units of measure include both standardized units of measure and non-standardized units of measure, and wherein the instructions for providing the user interface of the product include instructions for automatically selecting one of the two or more transaction units of measure according to the context.

9. The non-transitory computer-readable medium of claim 1, further comprising:
instructions for receiving, over a communication network, an electronic communication that includes an order for the product, wherein the order specifies an ordered quantity of the product according to a selected one of the two or more transaction units of measure, wherein the selected one of the two or more transaction units of measure is selected when the product is ordered to specify a quantity in the selected one of the two or more transaction units of measure for valuation of the product.

10. A computing system, comprising:
unit logic configured to define, in an electronic database that includes a record of an inventory, a product by defining at least (i) a standard unit of measure for the product and (ii) two or more transaction units of measure for the product,
wherein the two or more transaction units of measure are units used to value the product in different contexts, wherein the standard unit of measure is a unit of measure used to track the product within an inventory management system that includes the record of the inventory; and
display logic configured to provide a user interface, on an electronic display, associated with the product that includes one of the two or more transaction units of measure or the standard unit of measure according to at least the context of the user interface, wherein the context is defined according to at least a role of the user interface within the inventory management system.

11. The computing system of claim 10, wherein the standard unit of measure is a unit of measure that is standardized to account for quantities of the product in a management context, wherein the two or more transaction units of measure are units of measure for measuring the product according to a consumer transaction context, and wherein the management context defines a set of attributes associated with managing the inventory, wherein the consumer transaction context defines a set of attributes associated with retail transactions of the product, and wherein the consumer transaction context varies according to a geographic region, societal standards, user preference, government regulations, and transacting quantities.

12. The computing system of claim 10, wherein the role is defined according to a use of the user interface in the inventory management, wherein the use includes sales, management and product fulfillment, and
wherein the unit logic is configured to concurrently maintain records for the products in the two or more transaction units of measure and the standard unit of measure.

13. The computing system of claim 10, wherein the unit logic is configured to generate an electronic update to the record of the inventory in response to receiving an order for the product that specifies an ordered quantity in a selected one of the two or more transaction units of measure, wherein the unit logic is configured to generate the update by converting the ordered quantity to the standard unit of measure from the selected one of the two or more transaction units of measure.

14. The computing system of claim 13, wherein the unit logic is configured to generate the electronic update by generating one or more requests associated with the order that specify the ordered quantity in a unit of measure according to a context of each of the one or more requests, wherein the one or more requests are requests to different aspects of the inventory management system.

15. The computing system of claim 10, wherein the display logic is configured to provide the user interface by automatically converting a relevant quantity of the product from the standard unit of measure to one of the two or more transaction units of measure, and wherein the display logic is configured to select the selected one of the two or more transaction units of measure according to a context of the user interface.

16. The computing system of claim 10, wherein the display logic is configured to provide the user interface by causing a graphical user interface that includes a representation of the product to be rendered, wherein the unit logic is configured to define the product by generating an object in the electronic database that represents the product, and wherein the unit logic is configured to generate the object by generating a plurality of attributes of the product that include the standard unit of measure and the two or more transaction units of measure.

17. The computing system of claim 10, wherein the two or more transaction units of measure include both standardized units of measure and non-standardized units of measure, and wherein the display logic is configured to provide the user interface of the product by automatically selecting one of the two or more transaction units of measure according to the context.

18. A method, comprising:
providing, on an electronic display, a user interface that includes a representation of at least one product by generating the user interface with a selected one of two or more units of measure for the product according to at least a context of the user interface, wherein the context is defined according to at least a role of the user interface within an inventory management system, and
wherein the two or more units of measure include a standard unit of measure and at least one transaction unit of measure; and
maintaining, in an electronic database that includes records of an inventory, one or more records associated with the product by concurrently using the two or more units of measure.

19. The method of claim 18, wherein the standard unit of measure is defined in the one or more records as a unit of measure that is standardized for accounting for quantities of the product in a management context that includes tracking the product in the electronic database; and
wherein the two or more transaction units of measure are defined in the one or more records as units of measure for measuring the product in a consumer transaction context, and wherein the consumer transaction context varies according to a geographic region, societal standards, user preference, government regulations, and transacting quantities.

20. The method of claim 18, wherein electronically maintaining the one or more records associated with the product includes updating the one or more records in response to a request by converting quantities in the request into the standard unit of measure, and wherein providing the user interface includes automatically converting a relevant quantity of the product from the standard unit of measure to one of the two or more transaction units of measure, and wherein the selected one of the two or more transaction units of measure is selected according to a context of the user interface.
